(19) United States
(12) Patent Application Publication
(10) Pub. No.: US 2015/0267799 A1
(43) Pub. Date: Sep. 24, 2015

(54) AXLE CARRIER RETAINER

(71) Applicant: Anthony Porto, Albuquerque, NM (US)

(72) Inventor: Anthony Porto, Albuquerque, NM (US)

(21) Appl. No.: 14/220,519

(22) Filed: Mar. 20, 2014

(51) Int. Cl. F16H 57/023

(52) U.S. Cl. CPC F16H 57/023; F16H 2057/0062

(57) ABSTRACT

An axle carrier retainer to support an axle carrier comprising a pair of L-shaped supports, where the L shaped supports include: a first side; and a second side meeting the first side perpendicularly, where the second side includes an extended end thereby making the second side longer than the first side to receive the axle carrier; a threaded rod attached between the pair of L-shaped supports, where the threaded rod is fastened to the second side at a first end; and a fastening means to secure the threaded rod between the L-shaped supports.

### BACKGROUND OF THE INVENTION

1. Field of the Invention

The present invention relates to a device to secure an axle carrier while managing the axle gearing.

2. Description of Related Art

Vehicle repairs are typically very time consuming requiring knowledgeable technicians and specialized equipment. Axle working can be especially tricky because of the balancing act required between the two ends and the rear and front of the vehicle. Commonly during axle repair the carrier bearing races are prone to falling off while the carrier assembly is being placed back into the housing. As such, careful and precise installation techniques are required to keep the bearing races in place without a specialized tool or brace.

Therefore, it would be beneficial in the art to provide a tool to assist a user to install vehicle carrier bearing races. It would also be desirable for the installation tool to be easy to set up and tear down for quick and easy installation.

### SUMMARY OF THE INVENTION

In view of the foregoing disadvantages inherent in the prior art, the general purpose of the present invention is to provide an axle carrier retainer to support an axle carrier, configured to include all of the advantages of the prior art, and to overcome the drawbacks inherent therein.

Accordingly, an object of the present invention is to provide a tool that positions an axle carrier to secure the bearings and prevent the bearings from falling off during axle carrier installation.

To achieve the above objects, in an aspect of the present invention, an axle carrier retainer is described comprising a pair of L-shaped supports, where the L shaped supports include: a first side; and a second side meeting the first side perpendicularly, where the second side includes an extended end thereby making the second side longer than the first side to receive the axle carrier; a threaded rod attached between the pair of L-shaped supports, where the threaded rod is fastened to the second side at a first end; and a fastening means to secure the threaded rod between the L-shaped supports.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an axle carrier retainer in accordance with an exemplary embodiment of the present invention.

FIG. 2 depicts a backside view of an axle carrier retainer in accordance with an exemplary embodiment of the present invention; and

FIG. 3 depicts a side view of an axle carrier retainer in accordance with an exemplary embodiment of the present invention.

Like reference numerals refer to like parts throughout the description of several views of the drawings.

### DETAILED DESCRIPTION OF THE DRAWINGS

The present invention relates to a device to secure an axle carrier while managing the axle gearing. The present invention relates to an axle carrier retainer to quickly complete vehicle repairs when working on the axle. The axle carrier retainer includes a pair of steel angles. The steel angles are cut and bent in a manner which allows them to sit on the outside face of opposing vehicle races. The pair of steel angles is fastened together with a threaded rod. The threaded rod is long enough to allow use of the axle carrier retainer with GM 14 bolt full float carriers and even Dana 30 carriers. With the axle carrier retainer the user is afforded quick and easy installation of the axle carrier while simultaneously retaining the bearing races.

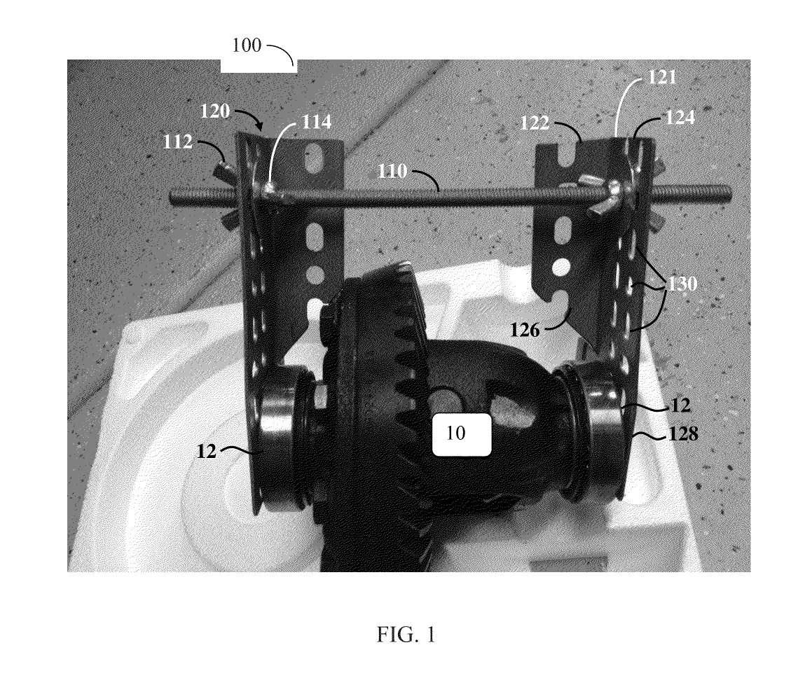

Turning now descriptively to the drawings, referring to FIG. 1, an axle carrier retainer 100 is shown in accordance with an exemplary embodiment of the present invention. The axle carrier retainer 100 includes a threaded rod 110 which extends greater than the width of an axle carrier 10. The threaded rod 110 is positioned between a pair of L-shaped supports 120 steel angles. The threaded rod 110 includes a pair of outer wing nuts 112 and a pair of inner wing nuts 114 which are screwed onto each end of the rod 110 after positioning the threaded rod 110 within the pair of L-shaped supports 120 for installation of the axle carrier 10.

The pair of L-shaped supports 120 includes a first side 122 and a second side 124. The first side 122 is fastened perpendicularly to the second side 124. The second side 124 receives the threaded rod 110 at a first end 121. The inner wing nuts 112 and the outer wing nuts 114 are positioned accordingly on the second side 124 of the L-shaped supports 120. The first side 122 and the second side 124 include a plurality of receiving holes 130. The receiving holes 130 on the second side 124 receive the threaded rod 110 for attachment. At an elongated end 128 of the second side 124 is where the bearings 12 of the axle carrier 10 are attached to secure the axle carrier 10 within the axle carrier retainer 100. The first side 122 includes an angled end 126 opposite from where the threaded rod 110 is attached at the first end 121 of the L-shaped support 120. The angled end 126 enables the carrier 10 to easily fit between the L-shaped supports 120 without interference. The first side 122 may be 3 inches in length, while the second side 124 may be 6 inches in length.

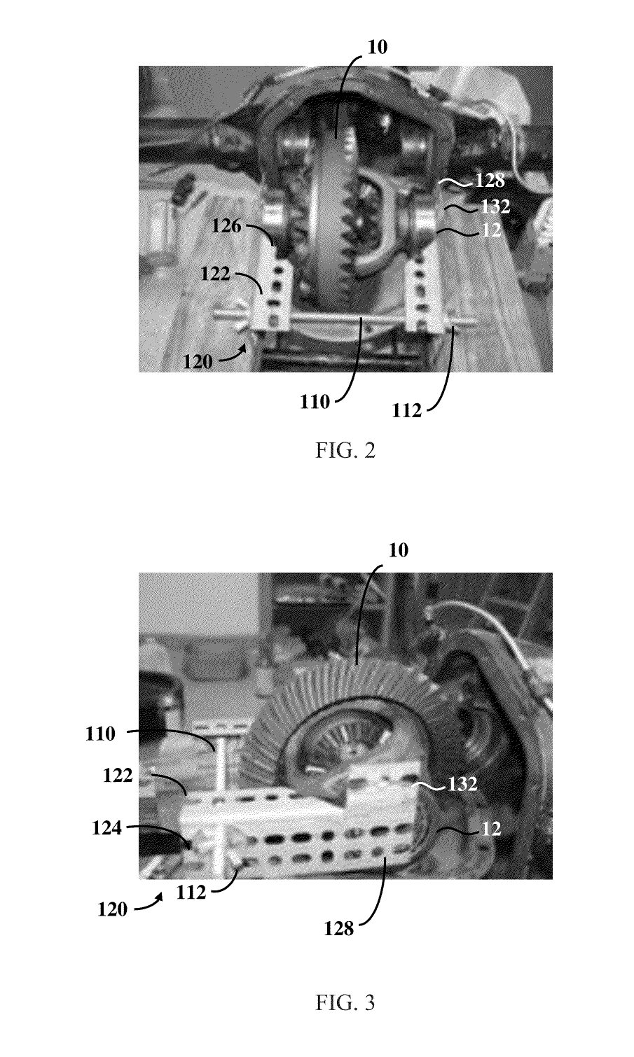

Referring now to FIG. 2, a backside view of the axle carrier retainer 100 is shown. The L-shaped supports 120 are adjustably fitted to secure the bearings 12. Extending from the elongated end 128 may be an extension 132. The extension 132 further supports the elongated end 128 of the second side to keep the axle carrier 10 within the L-shaped supports 120.

Referring now to FIG. 3, a side view of the axle carrier retainer 100 is shown. The extension 132 is illustrated projecting from the elongated end 128, creating an L-shape of the second side 124. The extension 132 projects perpendicularly from the orientation of the first side 122. The extension 132 is supportive and provides greater leverage to the second side 124 when installing the axle carrier 10.

During use, the axel carrier 10 slides into the L-shaped supports 120. The width between the L-shaped supports 120 is adjustable using the wing nuts 112, 114 to thereby move the L-shaped supports 120 along the threaded rod 110. The axle carrier retainer 100 supports the axle carrier 10 until the axle carrier 10 is dropped into the axle case, at which point the axle carrier retainer 100 slides out of the way. The axle carrier retainer 100 keeps the bearings 12 from falling off during installation. Typically, the axle carrier 10 is inserted by hand inside the case with the bearings 12 positioned securely within the extended end 128 of the second side 124. The threaded rod 110 is adjusted such that there is tension against the carrier bearings 12 to keep them in place. As the axle carrier 10 enters the case the axle carrier retainer 100 merely slides back out of the way for installation to be completed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An axle carrier retainer to support an axle carrier comprising:
a. a pair of L-shaped supports, where the L shaped supports include:
i. a first side; and
ii. a second side meeting the first side perpendicularly, where the second side includes an extended end thereby making the second side longer than the first side to receive the axle carrier;
b. a threaded rod attached between the pair of L-shaped supports, where the threaded rod is fastened to the second side at a first end; and
c. a fastening means to secure the threaded rod between the L-shaped supports.

2. The axle carrier retainer according to claim 1, where the first side includes an angled end opposite to the first end, where the angled end prevents interference when the axle carrier is in position between the pair of L-shaped supports.

3. The axle carrier retainer according to claim 1, where the fastening means is a pair of outer wing nuts and a pair of inner wing nuts fastened on each side of the second side of the L-shaped support.

4. The axle carrier retainer according to claim 1, where the first side and the second side include a plurality of receiving holes

5. The axle carrier retainer according to claim 4, where the plurality of receiving holes on the second end receive the threaded rod.

6. The axle carrier retainer according to claim 1, where the extended end of the second side includes an extension protruding perpendicularly from the orientation of the first side, where the extension further supports the extended end to retain the bearings.
